(19) United States
(12) Patent Application Publication
(10) Pub. No.: US 2003/0076402 A1
(43) Pub. Date: Apr. 24, 2003

(54) Image forming apparatus

(75) Inventor: Masanori Asakura, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/264,209

(22) Filed: Oct. 3, 2002

(30) Foreign Application Priority Data
Oct. 18, 2001 (JP) 2001-320101

(51) Int. Cl. B41J 2/435

(52) U.S. Cl. 347/234

(57) ABSTRACT

An image forming apparatus includes an image data transfer unit that transfers image data having a predetermined number of pixels to a print head. A clock signal transfer unit transfers a clock signal in synchronization with the number of pixels of the image data, the clock signal having the same number of pulses as the number of pixels of the image data. A transfer control unit that modifies a transfer time of the image data compared with a clock signal transfer time according to a margin to be formed.

### BACKGROUND OF THE INVENTION

1. Field of the Invention

The present invention relates to an image forming apparatus including a copying machine, facsimile apparatus, and a multi function peripheral (MFP) having multiple functions such as a copying and a facsimile function.

2. Description of the Related Art

In general, a printer such as an LED (Light Emitting Diode) printer, which is included in an image forming apparatus, synchronizes image data with a clock signal, and transfers the image data to an LED print head. When this kind of printer prints an image in the center of the paper, as illustrated in FIG. 4A and FIG. 5A, image data is transferred in parallel with the clock signal. Meanwhile, if a margin is formed on either side of the paper for making punch holes, for example, the image has to be moved to either side of the paper. The conventional ways of making large margins on either side of the paper are as follows: the left margin is enlarged by reducing the number of pulses of the clock signal compared with the number of pixels of the image data in the scanning direction (refer to FIG. 4B), or the right margin is enlarged by increasing the number of pulses of the clock signal compared with the number of pixels of the image data (refer to FIG. 4C). Also, the left margin is enlarged by replacing predetermined pixels on the left end of the image data with white-colored pixels (refer to FIG. 5B), or the right margin is enlarged by replacing predetermined pixels on the right end of the image data with white-colored pixels (refer to FIG. 5C).

Regarding the conventional ways of making large margins, reducing or increasing the number of pulses of the clock signal creates a problem in that a circuit generating clock signal becomes complicated as the number of clock pulses of the clock signal must be changed according to the margin size. Moreover, the way that predetermined pixels of image data on either side of the paper is replaced with white-colored pixels also creates a problem in that a process for replacing a part of the image data with the white-colored pixels is needed.

### SUMMARY OF THE INVENTION

It is an advantage of the present invention to provide an image forming apparatus having a simple process and circuit configuration, which creates a large margin on the left or right side of a recording paper.

The image forming apparatus of the present invention includes an image transfer unit that transfers data of a predetermined pixel to a print head, a clock signal transfer unit that transfers a clock signal synchronizing the image data and having the same number of pulses as the number of pixels of the image data, and a transfer control unit that advances or delays the transfer start timing of the image data compared with the transfer of the clock signal according to the margin size to be formed on the paper. Since large margins on the left or the right side of the paper can be formed by advancing or delaying the image data transfer time compared with the clock signal transfer time, there is no need for replacing image data with white-colored pixels or changing the number of pulses of the clock signal, and the process and the circuit configuration becomes simple.

If the transfer control unit in the image forming apparatus of the present invention forms a large left margin, the transfer control unit controls such that the start of transferring the image data is delayed from the start of transferring the clock signal.

Moreover, if the transfer control unit in the image forming apparatus of the present invention forms a large right margin, the transfer control unit controls such that the image data transfer is started earlier than the clock signal transfer.

The image forming apparatus of the present invention can make a large left or right margin, only by making the image data transfer start earlier or later than the start of transferring the clock signal.

### BRIEF DESCRIPTION OF THE DRAWINGS

FIG. 1 is a block diagram illustrating a configuration of image forming apparatus in a preferred embodiment of the present invention.

FIG. 2 is a block diagram illustrating an internal configuration of an image processing unit of the image forming apparatus in the preferred embodiment of the present invention.

FIG. 3A is a diagram, which explains a process of recording an image in the center of a paper.

FIG. 3B is a diagram, which explains a process of recording an image with forming a left margin largely.

FIG. 3C is a diagram, which explains a process of recording an image with forming a right margin largely.

FIG. 4A is a diagram, which explains a process of recording an image in the center of a paper in a conventional image forming apparatus.

FIG. 4B is a diagram, which explains a process of recording an image with forming a left margin largely in a conventional image forming apparatus.

FIG. 4C is a diagram, which explains a process of recording an image with forming a right margin largely in a conventional image forming apparatus.

FIG. 5A is a diagram, which explains a process of recording an image in the center of a paper in the other conventional image forming apparatus.

FIG. 5B is a diagram, which explains a process of recording an image with forming a left margin largely in the other conventional image forming apparatus.

FIG. 5C is a diagram, which explains a process of recording an image with forming a right margin largely in the other conventional image forming apparatus.

### DETAILED DESCRIPTION OF THE INVENTION

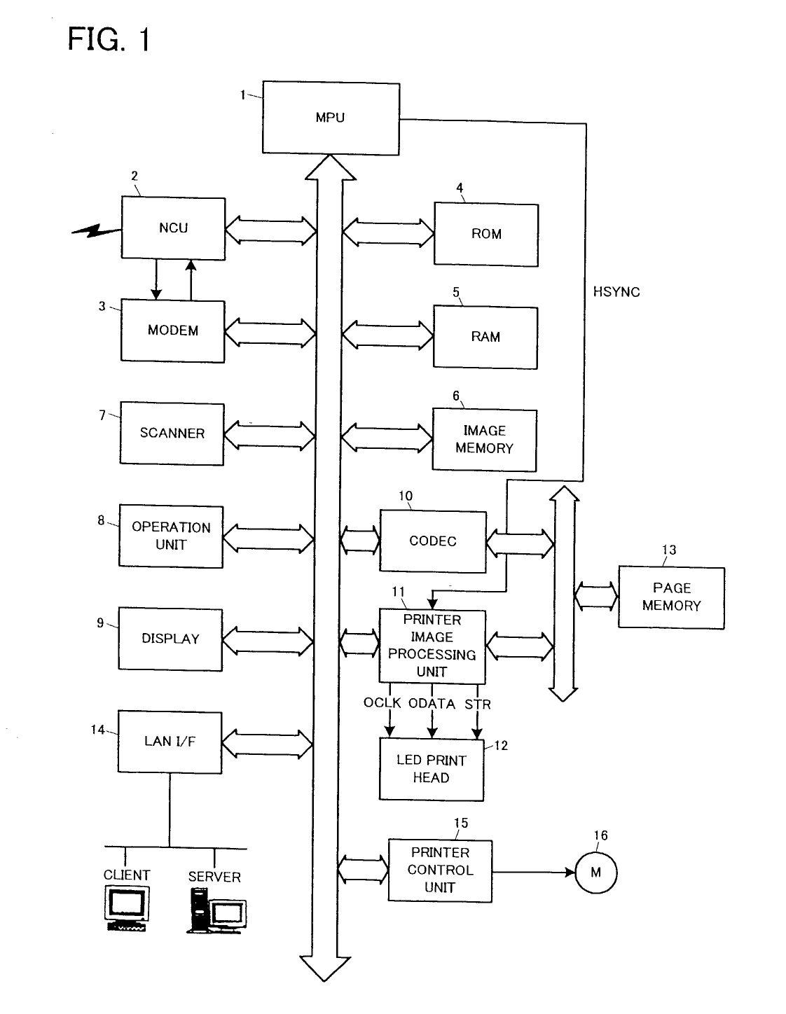

The present invention will be described below in more detail referring to a preferred embodiment. FIG. 1 is a block diagram illustrating a configuration of an entire image forming apparatus in a preferred embodiment of the present invention.

The image forming apparatus included as a so-called multi function peripheral having facsimile and copying functions, and equipped with MPU 1, NCU (Network Control Unit) 2, MODEM 3, ROM 4, RAM 5, an image memory (DRAM) 6, a scanner 7, an operation unit 8, a display 9, CODEC (Coder and Decoder) 10, an image processing circuit 11, an LED print head 12, a page memory 13, LAN I/F 14, a printer control unit 15, and a motor 16.

The MPU 1 has a function of controlling the respective parts including the image forming apparatus. The NCU 2 controls the connection with a public switched telephone network (PSTN), and has functions of sending out an address signal in response to the destination telephone number and of detecting a ring. The MODEM 3 modulates transmit data and demodulates received data in accordance with ITU (International Telecommunication Union)-T Recommendation V.17, V.27ter, and V29, etc., based on the facsimile transmit control procedure in accordance with ITU-T Recommendation T.30. Alternatively, the transmit data is modulated and the received data is demodulated in accordance with ITU-T Recommendation V.34 in addition to the above procedure.

The ROM 4 stores programs for controlling the image forming apparatus. The RAM 5 stores data, etc. to be processed by the MPU 1 temporarily. The image memory 6 stores received image data and image data read by the scanner 7. The scanner 7 reads image data of a document when faxing or copying. The operation unit 8 includes key switches such as a numeric keypad, a FAX key, a COPY key, a start key, and one touch dial key. The display 9 displays information etc. that is transmitted from the image forming apparatus, by which the operator can confirm the operational condition of the image forming apparatus. The CODEC 10 encodes read data for the transmission and decodes received image data, using MH, MR, MMR, and JBIG coding schemes. The image processing circuit 11 reads out the image data to be printed that is stored in the page memory 13, processes the image, and supplies a print data ODATA, an OCLK signal, and a STR signal, etc. to the LED print head 12. The image processing circuit 11 controls such that the image data and the clock signal, etc. are transferred to the LED print head 12 based on the instructions from the operation unit 8, and the image is recorded in the center of a paper, recorded after forming a large right margin, or recorded after forming a large left margin, with the LED print head 12.

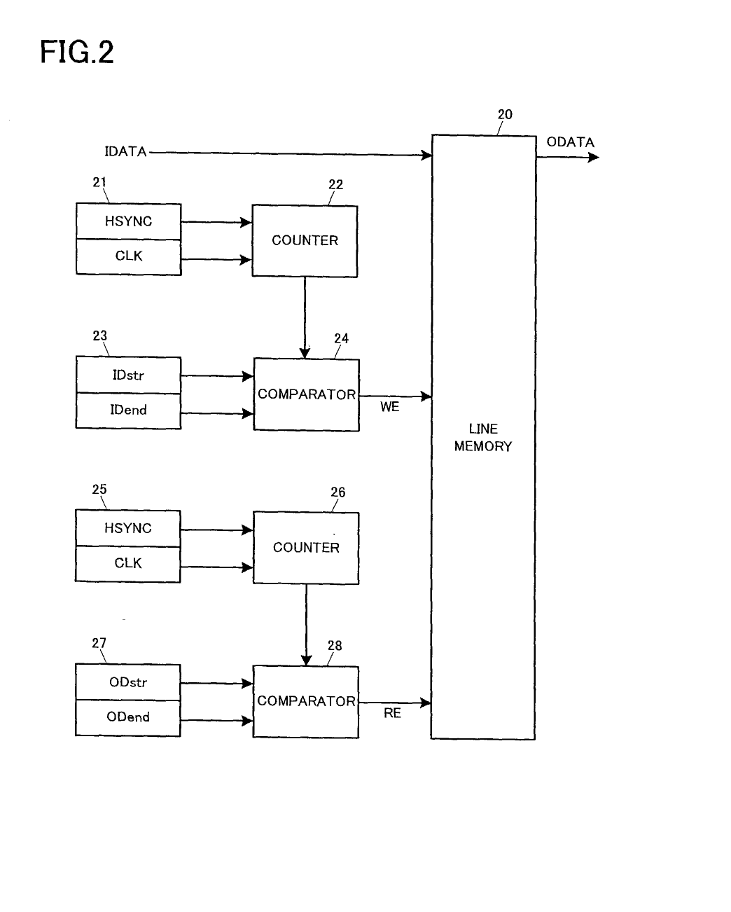

FIG. 2 is a block diagram illustrating the internal configuration of the image processing circuit 11. The image processing circuit 11, which imports and stores an input image data IDATA, includes a line memory 20 that outputs the image data ODATA, an input part 21 of a horizontal synchronization signal HSYNC and the clock signal CLK, a register 23 that stores an image data input start number IDstr and an image data input end number IDend, a counter 22 that counts the clock signal, a comparator 24 that compares the number that is counted by the counter 22 with the IDstr and IDend when receiving the signal from the counter 22 and the register 23 and outputs a write enable signal (WE) to the line memory 20. Moreover, the image processing circuit 11 includes an input part 25 of the horizontal synchronization signal HSYNC and the clock signal CLK, a counter 26 that counts the clock signal CLK, a register 27 that stores an image data output start number ODstr and an image data output end number ODend, and a comparator 28 that outputs a read enable signal (RE) to the line memory 20 if the count number of the counter 26 corresponds to ODstr and ODend when receiving the signal from the counter 26 and the input part 27.

The line memory 20 stores at least one line of image data. The timing of storing image data is determined by the image data input start number IDstr and the image data output start number IDend. When the counter 22 is reset by the HSYNC and counts the pulse of the CLK signal by the IDstr, the write enable signal WE is output from the comparator 24, and the image data is started to be written in the line memory 20. The image data is going to be written in the line memory 20, synchronizing the CLK signal. When the counter 22 counts the pulse of the CLK signal by the IDend, the comparator 24 stops outputting the write enable signal WE, and one line of the image data is written in the line memory 20.

The timing of reading out the image data from the line memory 20 is determined by the image data output start number ODstr and the image data output end number ODend. When the counter 26 is reset by the HSYNC and counts the pulse of the CLK signal by the ODstr, the readout signal RE is output from the comparator 28, and the image data is read out from the line memory 20, synchronizing the CLK signal. After the counter 26 counts the pulse of the CLK signal by the ODend, the comparator 26 stops outputting the readout signal RE, and the output of one line of image data is terminated.

The MPU 1 writes the ODstr and the ODend in the register 27 before printing. The MPU 1 sets the suitable ODstr and ODend, according to the cases of recording the image in the center of the paper, forming the left margin largely, and forming the right margin largely. Additionally, the CLK signal that is transmitted to the LED print head in a fixed timing is the OCLK signal.

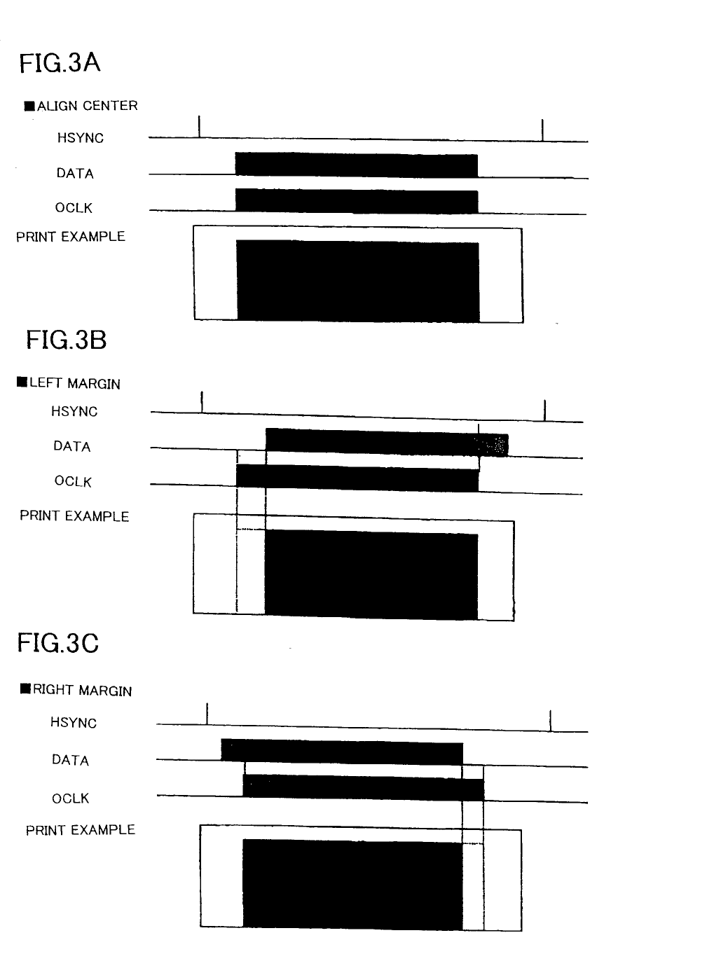

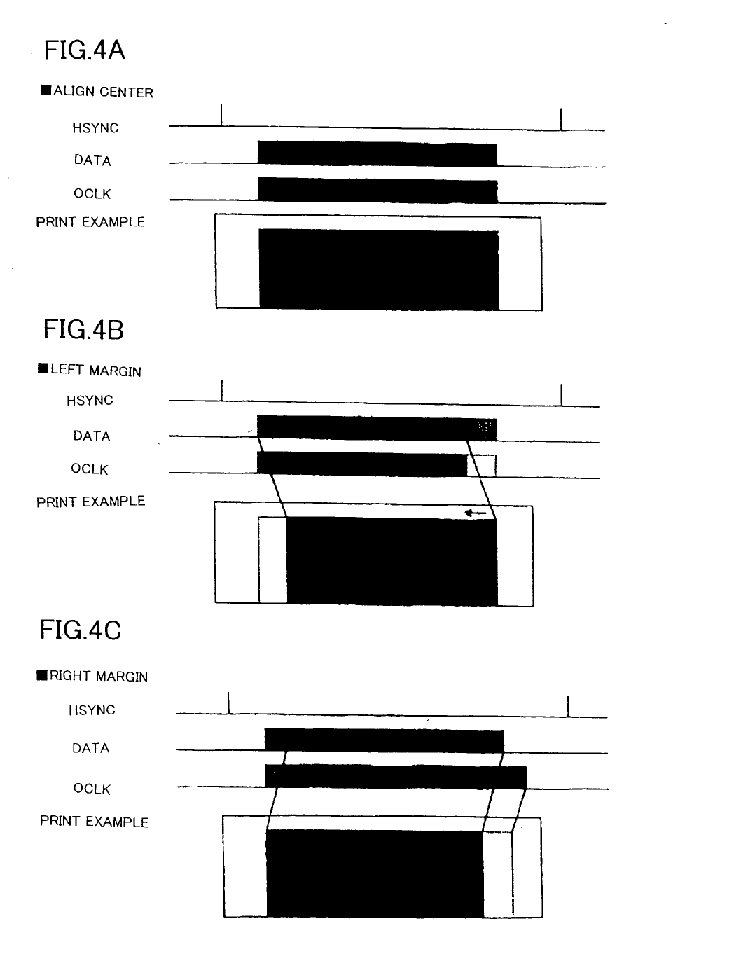

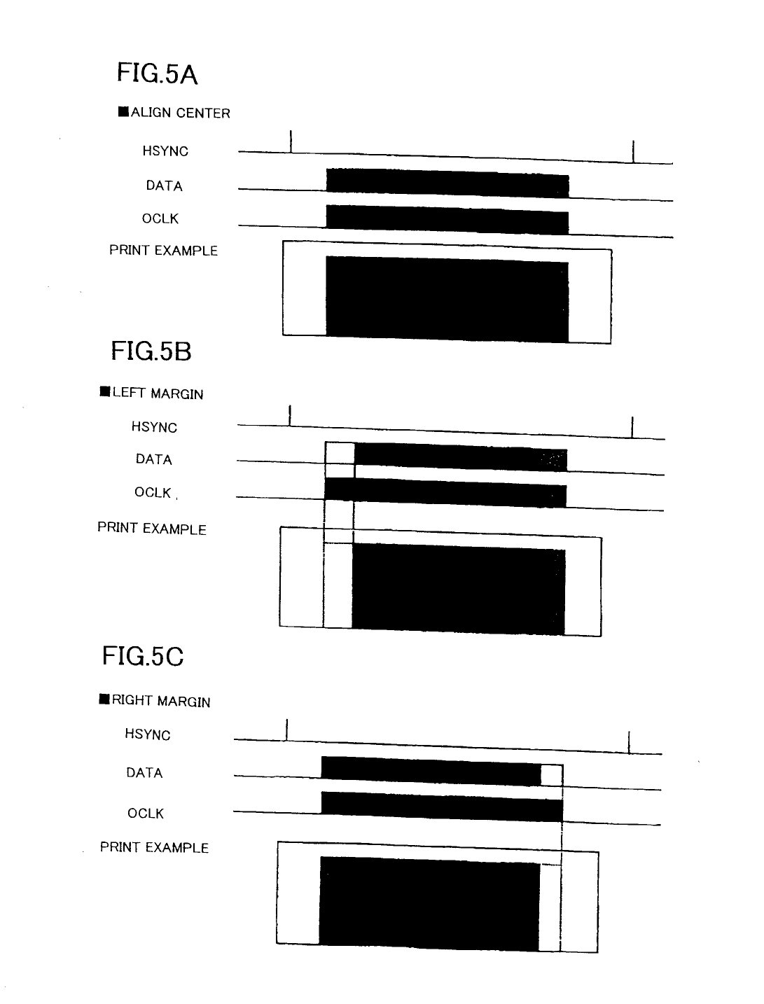

Next, regarding the preferred embodiment of the present invention, the respective image processing for recording an image in the center of the paper, forming a large left margin, and forming a large right margin will be described with reference to FIG. 3.

First, if an image is recorded in the center of the paper, as illustrated in FIG. 3A, the image data and the clock signal are transferred at the same time in a predetermined timing (so as to record the image in the center of the paper) after the HSYNC is output. Thus, the line memory 20 reads out the image data such that the image comes to the center of the paper when recording, and the image data is transmitted to the LED print head 12. Therefore, the center of the paper and the center of the image are accorded as illustrated in the print example in FIG. 3A.

Next, if a large left margin is formed, as illustrated in FIG. 3B, the OCLK signal is transferred at the same time as that illustrated in FIG. 3A, however, the transfer of the image data starts after the start of the transfer of the OCLK signal. The time of the delay is determined by the ODstr. The image data is not output while the OCLK signal starts and each pixel is set as white in color in the LED print head 12. Meanwhile, regarding the right end, the transfer of the OCLK signal terminates at the same time as that illustrated in FIG. 3A, so that the transferred image data is not input to the LED print head after the OCLK signal terminates. Additionally, the output of the image data is terminated when the number of the counter 26 is accorded to the ODend. Consequently, the LED print head 12 is driven by the image data whose left-side pixel becomes white in color, and a large left margin on the paper is formed as illustrated in the print example of FIG. 3B.

If a large right margin is formed on the paper, as illustrated in FIG. 3C, the OCLK signal is transferred at the same time as that illustrated in FIG. 3A, however, the transfer of the image data starts earlier than the start of the transfer of the OCLK signal. The time of the advancement is determined by the ODstr. Moreover, the transfer of the image data terminates earlier than the end of the transfer of the OCLK signal only by the pixel number specified by the ODend. After the transfer of the image data has terminated, each pixel is input in the LED print head 12 as white in color even if the OCLK signal is input. Consequently, when the image data is printed by the LED print head 12, a large right margin of a paper is formed as illustrated in the print example in FIG. 3C.

The LED printer is used in the preferred embodiment of the present invention, however a thermal printer and a thermal transfer printer using the thermal print head can be also applied to the present invention.

What is claimed is:

1. An image forming apparatus comprising:
an image data transfer unit that transfers image data having a predetermined number of pixels to a print head;
a clock signal transfer unit that transfers a clock signal in synchronization with the number of pixels of the image data, the clock signal having the same number of pulses as the number of pixels of the image data; and
a transfer control unit that modifies a transfer time of the image data compared with a clock signal transfer time according to a margin to be formed.

2. The image forming apparatus as in claim 1, wherein the transfer control unit delays the transfer of the image data compared with the start of transferring the clock signal, when a large left margin is to be formed.

3. The image forming apparatus as in claim 1, wherein the transfer control unit advances the transfer of the image data compared with the start of transferring the clock signal, when a large right margin is to be formed.

4. The image forming apparatus as in claim 1, wherein the image data transfer control unit comprises:
a line memory that stores at least one line of the image data;
a counter that is reset by a horizontal synchronization signal and counts the number of pulses of the clock signal;
a register that stores a number for determining the start of outputting the image data and a number for terminating the output of the image data; and
a comparator that outputs a read enable signal of the line memory when the number counted by the counter is between the number for determining the start of outputting the image data and the number for determining the termination of outputting data.

5. The image forming apparatus as in claim 4, wherein the transfer control unit writes the number for determining the start of outputting the image data and the number for determining the termination of outputting data in the register.

6. An image forming apparatus comprising:
an image data transfer means that transfers image data having a predetermined number of pixels to the print head;
a clock signal transfer means that transfers a clock signal in synchronization with the number of pixels of image data, the clock signal having the same number of pulses as the number of pixels of the image data; and
a transfer control means that modifies a transfer timing of the image data compared with a clock signal transfer time based on the margin to be formed.

7. The image forming apparatus as in claim 6, wherein the transfer control means delays the transfer of image data compared with the start of transferring the clock signal, when a large left margin is to be formed.

8. The image forming apparatus as in claim 6, wherein the transfer control means advances the transfer of image data compared with the start of transferring the clock signal, when a large right margin is to be formed.

9. The image forming apparatus as in claim 6,
wherein the image data transfer control means comprises:
a first memory means that stores at least one line of the mage data;
a count means that counts the number of pulses of the clock signal, which is reset by the horizontal synchronization signal;
a second memory means that stores a number for determining the start of outputting image data and a number for determining the termination of outputting the image data; and
a comparing means that outputs the read enable signal of the first memory means, when the number that is counted by the count means is between the number for determining the start of outputting image data and the number for determining the termination of outputting the image data.

10. The image forming apparatus as in claim 9, wherein the transfer control means writes the number for determining the output of the image data and the number for determining the termination of outputting the image data in the second memory.

11. The image forming apparatus as in claim 2, wherein the delay is determined by an image data output start number.

12. The image forming apparatus as in claim 3, wherein the advancement is determined by an image data output start number.

13. The image forming apparatus as in claim 1, wherein a number of pixels having a different color than the predetermined number of pixels, are output when the transfer control unit modifies the transfer time.

14. The image forming apparatus as in claim 1, wherein the image data is terminated at an image data output end number.

15. The image forming apparatus as in claim 7, wherein the delay is determined by an image data output start number.

16. The image forming apparatus as in claim 8, wherein the advancement is determined by an image data output start number.

17. The image forming apparatus as in claim 6, wherein a number of pixels having a different color than the predetermined number of pixels, are output when the transfer control unit modifies the transfer time.

18. The image forming apparatus as in claim 6, wherein the image data is terminated at an image data output end number.

19. A method for forming an image comprising:
transferring image data having a predetermined number of pixels
transferring a clock signal in synchronization with the number of pixels of the image data, the clock signal having the same number of pulses as the number of pixels of the image data; and
modifying a transfer time of the image data compared with a transfer time of the clock signal according to a margin to be formed.

20. The method according to claim 19, further comprising delaying the transfer of image data compared with the start of transferring the clock signal when a large left margin is to be formed.

21. The method according to claim 19, further comprising advancing the transfer of image data compared with the start of transferring the clock signal when a large right margin is to be formed.
